(19) United States
(12) Patent Application Publication
(10) Pub. No.: US 2019/0329602 A1
(43) Pub. Date: Oct. 31, 2019

(54) CENTRAL TIRE INFLATION SYSTEM

(71) Applicant: GM GLOBAL TECHNOLOGY OPERATIONS LLC, Detroit, MI (US)

(72) Inventors: Scott R. Pouls, Waterford (US); Robert G. Sutherlin, Farmington Hills (US)

(21) Appl. No.: 15/964,485

(22) Filed: Apr. 27, 2018

(51) Int. Cl. B60C 23/00; B60C 23/04

(52) U.S. Cl. CPC B60C 23/003; B60C 23/0491

(57) ABSTRACT

An exemplary system for controlling air pressure in a tire of a vehicle includes an air transfer ring assembly including a reservoir member, a cover member, a first air transfer member, a second air transfer member, and a sealing member configured to seal the reservoir member against the cover member and defining a pressured reserve air chamber. The reservoir member is coupled to a hub assembly of the vehicle and the cover member is coupled to a brake assembly of the vehicle to facilitate the transfer of air to and from a rotating vehicle component and a stationary vehicle component.

### INTRODUCTION

The present invention relates generally to the field of vehicles and, more specifically, to an air transfer ring and sealing assembly for a central tire inflation system.

Vehicles are often equipped with pressure-monitoring systems. A central tire inflation system uses the pressure-monitoring system to determine an optimal tire inflation pressure. However, central tire inflation systems can make removing the tire/wheel difficult when servicing the vehicle due to the typical routing of air from the chassis or stationary side of the vehicle to the tire/wheel or rotational components and vice versa.

### SUMMARY

Embodiments according to the present disclosure provide a number of advantages. For example, embodiments of an air transfer ring according to the present disclosure enable a transfer of air to and/or from the chassis or stationary side of the vehicle to the tire/wheel or rotational components of the vehicle independent of the wheel design.

In one aspect, a system for controlling air pressure in a tire of a vehicle includes an air transfer ring assembly including a reservoir member, a cover member, a first air transfer member, a second air transfer member, and a sealing member configured to seal the reservoir member against the cover member and defining a pressured reserve air chamber. The reservoir member is coupled to a hub assembly of the vehicle and the cover member is coupled to a brake assembly of the vehicle.

In some aspects, the reservoir member is a U-shaped member having a first end and a second end opposite and parallel to the first end.

In some aspects, the system further includes a first sealing member and a second sealing member, the first sealing member extending from a first side of the U-shaped member and the second sealing member extending from a second side of the U-shaped member.

In some aspects, the sealing member includes a plurality of lateral sealing members and a radial sealing member, the plurality of lateral sealing members sealing against a first portion of the cover member and the radial sealing member sealing against a second portion of the cover member.

In some aspects, the sealing member includes 3 lateral sealing members.

In some aspects, the sealing member further includes a compressive member, the compressive member engaging the radial sealing member against the cover member.

In some aspects, the compressive member is a garter spring.

In another aspect, an automotive vehicle includes a vehicle wheel assembly including a tire mounted on a hub assembly and defining a pressured tire air chamber, a brake assembly including a brake dust shield, and an air transfer ring assembly including a reservoir member, a cover member, a first air transfer member, a second air transfer member, and a sealing member configured to seal the reservoir member against the cover member and defining a pressured reserve air chamber. The reservoir member is coupled to the hub assembly of the vehicle and the cover member is coupled to the brake assembly of the vehicle. The sealing member includes a plurality of lateral sealing members and a radial sealing member, the plurality of lateral sealing members sealing against a first portion of the cover member and the radial sealing member sealing against a second portion of the cover member.

In some aspects, the hub assembly includes a hub flange and the reservoir member is coupled to the hub flange with a first coupling member.

In some aspects, the first air transfer member extends from the reservoir member through an opening in the hub flange.

In some aspects, the cover member is coupled to the brake dust shield of the brake assembly with a second coupling member.

In some aspects, the second air transfer member extends from the reservoir member through an opening in the brake dust shield.

In some aspects, the sealing member further includes a compressive member, the compressive member engaging the radial sealing member against the second portion of the cover member.

In some aspects, the compressive member is a garter spring.

In yet another aspect, a system for controlling air pressure in a tire of a vehicle includes an air transfer ring assembly including a reservoir member, a cover member, a first air transfer member, a second air transfer member, and a sealing member that seals the reservoir member against the cover member and defines a pressured reserve air chamber. The reservoir member is coupled to a hub assembly of the vehicle and the cover member is coupled to a brake assembly of the vehicle. The sealing member includes a plurality of lateral sealing members and a radial sealing member, the plurality of lateral sealing members sealing against a first portion of the cover member and the radial sealing member sealing against a second portion of the cover member.

In some aspects, the first portion of the cover member is perpendicular to the second portion of the cover member.

In some aspects, the sealing member includes 3 lateral sealing members.

In some aspects, the sealing member further includes a compressive member, the compressive member engaging the radial sealing member against the cover member.

In some aspects, the compressive member is a garter spring.

### BRIEF DESCRIPTION OF THE DRAWINGS

The present disclosure will be described in conjunction with the following figures, wherein like numerals denote like elements.

FIG. 1 is a schematic partial side view of a hub assembly for a vehicle front wheel, according to an embodiment.

FIG. 2 is a schematic side view of a hub assembly for a vehicle rear wheel, according to an embodiment.

FIG. 3 is a schematic diagram of a hub assembly including an air transfer assembly, according to an embodiment.

FIG. 4 is a close up view of the air transfer assembly of FIG. 3.

FIG. 5 is a schematic view of an air transfer ring for a central tire inflation system, according to an embodiment.

FIG. 6 is a close up view of a sealing area of the air transfer ring of FIG. 5.

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through the use of the accompanying drawings. Any dimensions disclosed in the drawings or elsewhere herein are for the purpose of illustration only.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

Central tire inflation systems include pressure-monitoring systems and inflation systems to inflate and/or deflate the tire to the desired level upon driver demand and during operation of the vehicle. Embodiments discussed herein disclose an inflation and sealing assembly that allows air transfer between a rotating object (tire/wheel) and a stationary object (frame/vehicle) with an easily-detachable fitting that connects the tire and the air source without use of a portal hub or spline, making the assembly independent of the wheel bearing and usable with a conventional wheel hub. In some embodiments, the central tire inflation system includes a cover, a sealing assembly, and a reservoir configured to fit between a brake dust shield and a wheel hub assembly such that the wheel/tire can be easily removed for service.

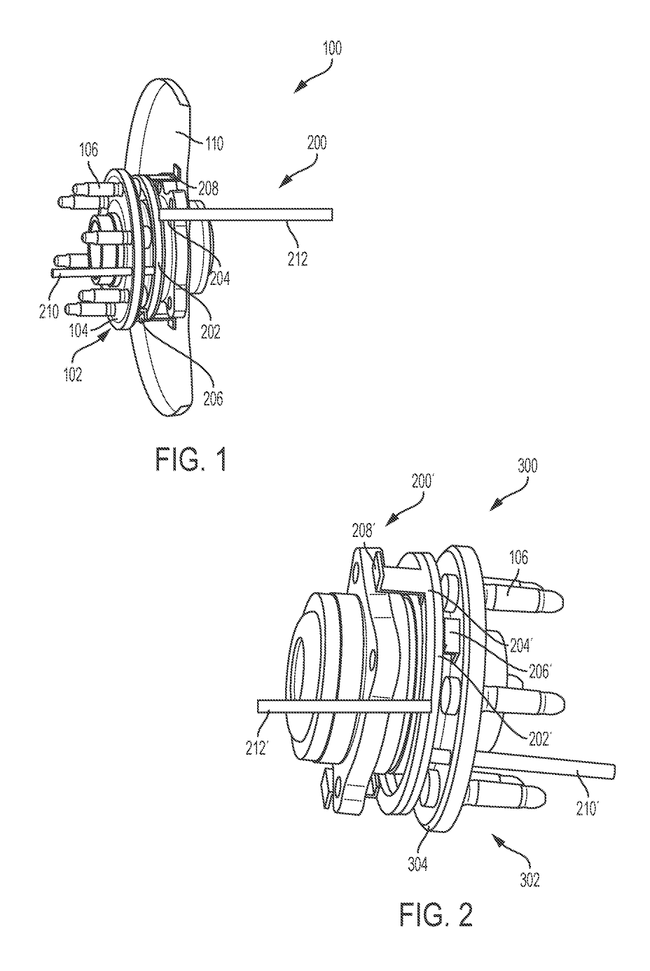

FIG. 1 is a schematic, partial side view representation of a tire 15 coupled to a non-solid axle wheel assembly 100 having a central tire inflation system 200, according to an embodiment. The interior of the tire 15 defines a pressured tire air chamber. Air can be transferred to and from the pressured tire air chamber via the central tire inflation system 200, as discussed herein.

The wheel assembly 100 includes a wheel hub assembly 102 and a brake assembly (not shown) which includes, in some embodiments, a brake dust shield 110. The wheel hub assembly 102 includes a flange assembly including a hub flange 104. A plurality of wheel studs 106 extend through the hub flange 104 for connection to the wheel or tire (not shown).

The central tire inflation system 200 is located between the wheel hub assembly 102 and the brake dust shield 110. In some embodiments, including the embodiment illustrated in FIG. 1, the central tire inflation system 200 includes an air transfer ring assembly including a reservoir member 202, a cover member 204, a first coupling member 206, a second coupling member 208, a first air transfer member 210, and a second air transfer member 212.

In some embodiments, the reservoir member 202 is a U-shaped member that acts as an air reservoir, containing and maintaining air at a pressure similar to that maintained within the tire, close to the tire. The reservoir member 202 is coupled to the hub flange 104 via the coupling member 206. In some embodiments, the coupling member 206 is a bracket or other type of mechanical connection member. In some embodiments, the coupling member 206 is welded to the hub flange 104. In some embodiments, the coupling member 206 is coupled to the hub flange 104 via any type of mechanical fastener or chemical coupling process. In some embodiments, the central tire inflation system 200 includes a plurality of coupling members 206 coupling the reservoir member 202 to the hub flange 104.

The cover member 204 seals against the reservoir member 202. The cover member 204 is coupled to the brake dust shield 110 via the coupling member 208. In some embodiments, a plurality of coupling members 208 couple the cover member 204 to the brake dust shield 110. In some embodiments, the coupling member 208 is a bracket or other type of mechanical connection member. In some embodiments, the coupling member 208 is welded to the brake dust shield 110. In some embodiments, the coupling member 208 is coupled to the brake dust shield 110 via any type of mechanical fastener or chemical coupling process.

The first air transfer member 210 extends from the reservoir member 202. The first air transfer member 210 extends through an opening in the hub flange 104. In some embodiments, the first air transfer member 210 connects to the tire via any type of pneumatic fitting, such as, for example and without limitation, a quick connect coupling (not shown). The first air transfer member 210 allows air to pass to and/or from the reservoir member 202 to the tire upon user demand. The quick connect coupling allows the wheel or tire to be easily disconnected from the central tire inflation system 200 for service.

The second air transfer member 212 extends from the reservoir member 202. The second air transfer member 212 extends through the brake dust shield 110 and connects the reservoir member 202 with a chassis-side source of air for the central tire inflation system 200. In some embodiments, the second air transfer member 212 is welded to the cover member 204 to allow air from the air source to enter and/or leave the reservoir member 202.

FIG. 2 is a schematic, partial side view representation of a solid axle assembly 300 having a central tire inflation system 200′, according to an embodiment. The wheel assembly 300 includes a wheel hub assembly 302 and a brake assembly (not shown). The wheel hub assembly 302 includes a flange assembly including a hub flange 304. A plurality of wheel studs 106 extend through the hub flange 304 for connection to the wheel or tire (not shown).

The central tire inflation system 200′ is located on the wheel hub assembly 302 opposite the wheel and in some embodiments is coupled to a dust shield (not shown). In some embodiments, including the embodiment illustrated in FIG. 2, the central tire inflation system 200′ includes an air transfer ring including a reservoir member 202′, a cover member 204′, a first coupling member 206′, a second coupling member 208′, a first air transfer member 210′, and a second air transfer member 212′.

In some embodiments, the reservoir member 202′ is a U-shaped member that acts as an air reservoir, containing and maintaining air at a pressure similar to that maintained within the tire, close to the tire. The reservoir member 202′ is coupled to the hub flange 304 via the coupling member 206′. In some embodiments, the coupling member 206′ is a bracket or other type of mechanical connection member. In some embodiments, the coupling member 206′ is welded to the hub flange 304. In some embodiments, the coupling member 206′ is coupled to the hub flange 304 via any type of mechanical fastener or chemical coupling process. In some embodiments, the central tire inflation system 200′ includes a plurality of coupling members 206′ coupling the reservoir member 202′ to the hub flange 304.

The cover member 204′ seals against the reservoir member 202′. The cover member 204′ is coupled to the brake assembly via the coupling member 208′. In some embodiments, a plurality of coupling members 208′ couple the cover member 204′ to the hub flange. In some embodiments, the coupling member 208′ is a bracket or other type of mechanical connection member. In some embodiments, the coupling member 208′ is welded to the axle assembly or dust shield (not shown). In some embodiments, the coupling member 208′ is coupled to the axle assembly or dust shield (not shown) via any type of mechanical fastener or chemical coupling process.

The first air transfer member 210′ extends from the reservoir member 202′. The first air transfer member 210′ extends through an opening in the hub flange 304. In some embodiments, the first air transfer member 210′ connects to the tire via any type of pneumatic fitting, such as, for example and without limitation, a quick connect coupling (not shown). The first air transfer member 210′ allows air to pass to and/or from the reservoir member 202′ to the tire upon user demand. The quick connect coupling allows the wheel or tire to be easily disconnected from the central tire inflation system 200′ for service.

The second air transfer member 212′ extends from the reservoir member 202′. The second air transfer member 212′ connects the reservoir member 202′ with a chassis-side source of air for the central tire inflation system 200′. In some embodiments, the second air transfer member 212′ is welded to the cover member 204′ to allow air from the air source to enter and/or leave the reservoir member 202′.

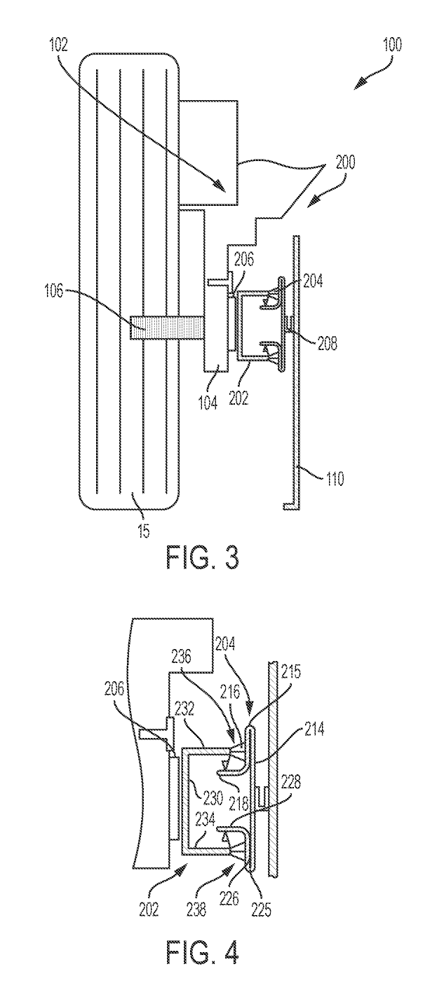

FIGS. 3-6 are schematic representations of details of components of the central tire inflation system 200. In some embodiments, the reservoir member 202 includes a channel member 230 connecting a first side member 232 and a second side member 234. The first side member 232 extends from a first end of the channel member 230 and the second side member extends from a second end of the channel member 230 opposite the first end. Each of the first and second side members 232, 234 are approximately perpendicular to the channel member 230 such that the members 230, 232, 234 form a channel.

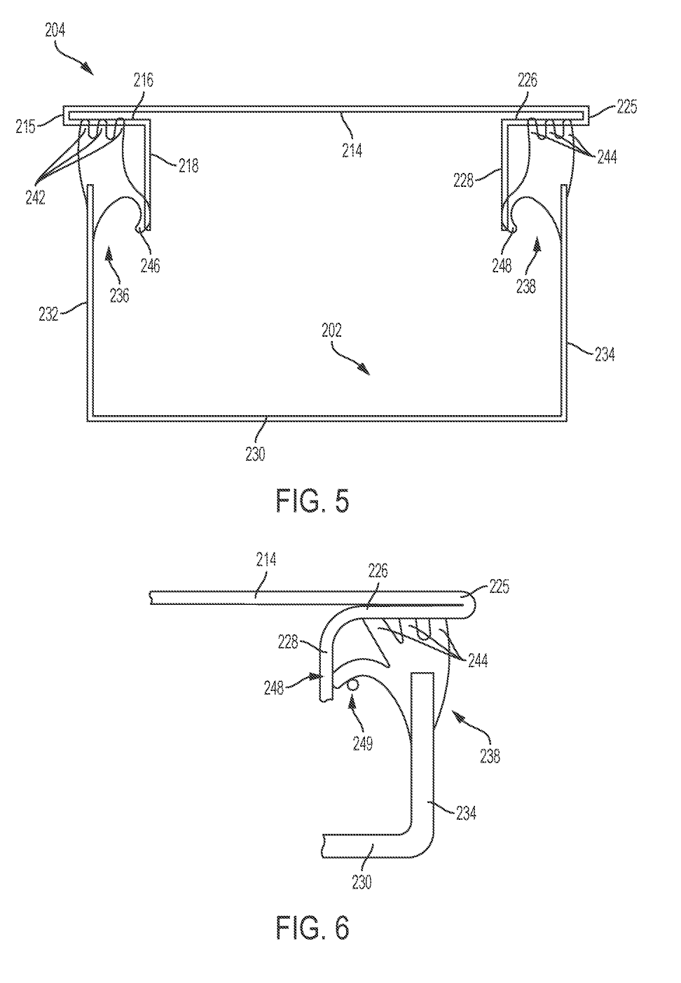

As shown in FIG. 3 and in greater detail in FIGS. 4-6, the reservoir member 202 includes sealing members 236, 238. The sealing members 236, 238 include radial and lateral sealing members to seal the reservoir member 202 against the cover member 204 to retain high pressure air within the reservoir member 202. As best illustrated in FIGS. 5 and 6, in some embodiments, the sealing member 236 includes a plurality of lateral sealing members 242. Similarly, in some embodiments, the sealing member 238 includes a plurality of lateral sealing members 244. In some embodiments, each of the sealing members 236, 238 include 3 lateral sealing members 242, 244. In other embodiments, each of the sealing members 236, 238 includes 2, 4, 5, or more lateral sealing members 242, 244. In some embodiments, the number of lateral sealing members 242, 244 depends on the pressure of the air contained within the reservoir member 202.

In some embodiments, each of the sealing members 236, 238 includes a radial sealing member 246, 248. In some embodiments, the sealing members 236, 238 are formed from a flexible material, such as rubber or a silicone-based material, and overmolded onto the first and second side members 232, 234 and may include a compressive member 249 (shown in FIG. 6) to engage at least a portion of each of the sealing members 236, 238 to the cover member 204, as discussed in greater detail herein. The material of the sealing members 236, 238 is selected based on vehicle operating conditions and environments, such as expected temperatures and air pressures, for example and without limitation.

As shown in FIGS. 4-6, in some embodiments, the cover member 204 includes flanges to facilitate sealing the reservoir member 202. In some embodiments, the flanges are formed from manipulating each end of the cover member 204 such that each end forms an L-shaped sealing surface. In some embodiments, a bend 215 orients an intermediate portion 216 approximately parallel with a cover portion 214. An end portion 218 includes a terminal end of the cover member 204 and is oriented approximately perpendicular to the intermediate portion 216 and the cover portion 214. Similarly, a bend 225 orients an intermediate portion 226 approximately parallel with the cover portion 214. An end portion 228 includes a terminal end of the cover member 214 and is oriented approximately perpendicular to the intermediate portion 226 and the cover portion 214.

The radial sealing members 246, 248 and lateral sealing members 242, 244 seal against the flanges of the cover member 204. The lateral sealing members 242 seal against the intermediate portion 216 and the lateral sealing members 244 seal against the intermediate portion 226. The radial sealing member 246 seals against the end portion 218 and the radial sealing member 248 seals against the end portion 228. The lateral and radial sealing members prevent contaminants from entering the reservoir member 202 and also maintain the air pressure within the reservoir member 202. The reservoir member 202, cover member 204, and the sealing members 236, 238 define a pressured reserve air chamber.

In some embodiments, as shown in FIG. 6, a compressive member 249 acts as a spring to engage the radial sealing member 248 against the end portion 228. In some embodiments, the compressive member 249 is a garter spring. While FIG. 6 illustrates one side of the central tire inflation system 200, it is understood that the compressive member 249 similarly acts on the radial sealing member 246 to seal the opposite side of the reservoir member 202.

As illustrated, the central tire inflation system 200 utilizes the existing brake dust shield 110 to mount the cover member 204 via the second coupling member 208. In some embodiments, the coupling member 208 is welded directly to the brake dust shield 110. In some embodiments, the coupling member 208 is a bracket.

As further illustrated in FIG. 3, the U-shaped reservoir member 202 is mounted to the inboard side of the wheel hub assembly 102 via the first coupling member 206. In some embodiments, the coupling member 206 is bolted to the hub flange 104. In some embodiments, the coupling member 206 is a bracket.

In some embodiments, one or both of the reservoir member 202, 202′ and the cover member 204. 204′ are stamped or machined rigid members made from a metal or metal alloy suitable for rotational sealing.

While FIGS. 1-6 illustrate one orientation of the central tire inflation systems 200, 200′, in other embodiments, the central tire inflation systems 200, 200′ may be oriented in the opposite direction. That is, in some embodiments, the reservoir member 202, 202′ is adjacent to the brake components of the vehicle, such as the brake dust shield 110, while the cover member 204, 204′ is mounted to the inboard side of the wheel hub assembly.

It should be emphasized that many variations and modifications may be made to the herein-described embodiments, the elements of which are to be understood as being among other acceptable examples. All such modifications and variations are intended to be included herein within the scope of this disclosure and protected by the following claims. Moreover, any of the steps described herein can be performed simultaneously or in an order different from the steps as ordered herein. Moreover, as should be apparent, the features and attributes of the specific embodiments disclosed herein may be combined in different ways to forrn additional embodiments, all of which fall within the scope of the present disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Moreover, the following terminology may have been used herein. The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” or “approximately” means that quantities, dimensions, sizes, formulations, parameters, shapes and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but should also be interpreted to also include individual values and sub-ranges within the indicated range. Thus, included in this numerical range are individual values such as 2, 3 and 4 and sub-ranges such as “about 1 to about 3,” “about 2 to about 4” and “about 3 to about 5,” “1 to 3,” “2 to 4,” “3 to 5,” etc. This same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A system for controlling air pressure in a tire of a vehicle, comprising:
an air transfer ring assembly including a reservoir member, a cover member, a first air transfer member, a second air transfer member, and a sealing member configured to seal the reservoir member against the cover member and defining a pressured reserve air chamber;
wherein the reservoir member is coupled to a hub assembly of the vehicle and the cover member is coupled to a brake assembly of the vehicle.

2. The system of claim 1, wherein the reservoir member is a U-shaped member having a first end and a second end opposite and parallel to the first end.

3. The system of claim 2, further comprising a first sealing member and a second sealing member, the first sealing member extending from a first side of the U-shaped member and the second sealing member extending from a second side of the U-shaped member.

4. The system of claim 1, wherein the sealing member comprises a plurality of lateral sealing members and a radial sealing member, the plurality of lateral sealing members sealing against a first portion of the cover member and the radial sealing member sealing against a second portion of the cover member.

5. The system of claim 4, wherein the sealing member comprises 3 lateral sealing members.

6. The system of claim 4, wherein the sealing member further comprises a compressive member, the compressive member engaging the radial sealing member against the cover member.

7. The system of claim 6, wherein the compressive member is a garter spring.

8. An automotive vehicle, comprising:
a vehicle wheel assembly including a tire mounted on a hub assembly and defining a pressured tire air chamber;
a brake assembly including a brake dust shield; and
an air transfer ring assembly including a reservoir member, a cover member, a first air transfer member, a second air transfer member, and a sealing member configured to seal the reservoir member against the cover member and defining a pressured reserve air chamber;
wherein the reservoir member is coupled to the hub assembly of the vehicle and the cover member is coupled to the brake assembly of the vehicle; and
wherein the sealing member comprises a plurality of lateral sealing members and a radial sealing member, the plurality of lateral sealing members sealing against a first portion of the cover member and the radial sealing member sealing against a second portion of the cover member.

9. The automotive vehicle of claim 8, wherein the hub assembly includes a hub flange and the reservoir member is coupled to the hub flange with a first coupling member.

10. The automotive vehicle of claim 9, wherein the first air transfer member extends from the reservoir member through an opening in the hub flange.

11. The automotive vehicle of claim 8, wherein the cover member is coupled to the brake dust shield of the brake assembly with a second coupling member.

12. The automotive vehicle of claim 11, wherein the second air transfer member extends from the reservoir member through an opening in the brake dust shield.

13. The automotive vehicle of claim 8, wherein the sealing member further comprises a compressive member, the compressive member engaging the radial sealing member against the second portion of the cover member.

14. The automotive vehicle of claim 13, wherein the compressive member is a garter spring.

15. A system for controlling air pressure in a tire of a vehicle, comprising:
an air transfer ring assembly including a reservoir member, a cover member, a first air transfer member, a second air transfer member, and a sealing member that seals the reservoir member against the cover member and defines a pressured reserve air chamber;
wherein the reservoir member is coupled to a hub assembly of the vehicle and the cover member is coupled to a brake assembly of the vehicle; and
wherein the sealing member comprises a plurality of lateral sealing members and a radial sealing member, the plurality of lateral sealing members sealing against a first portion of the cover member and the radial sealing member sealing against a second portion of the cover member.

16. The system of claim 15, wherein the first portion of the cover member is perpendicular to the second portion of the cover member.

17. The system of claim 15, wherein the sealing member comprises 3 lateral sealing members.

18. The system of claim 17, wherein the sealing member further comprises a compressive member, the compressive member engaging the radial sealing member against the cover member.

19. The system of claim 18, wherein the compressive member is a garter spring.
